(19) United States
(12) Patent Application Publication
(10) Pub. No.: US 2007/0057647 A1
(43) Pub. Date: Mar. 15, 2007

(54) Motor phase fault detection control

(75) Inventors: Richard M. Burkhart, St. Louis, MO (US); G. Scott Vogel, St. Louis, MO (US)

Correspondence Address: HARNESS, DICKEY, & PIERCE, P.L.C, 7700 BONHOMME, STE 400, ST. LOUIS, MO, 63105, US

(73) Assignee: Emerson Electric Co.

(21) Appl. No.: 11/225,534

(22) Filed: Sep. 13, 2005

(51) Int. Cl. H02P 1/42

(52) U.S. Cl. 318/786

(57) ABSTRACT

An apparatus is provided for controlling a single phase induction motor having a main winding, an auxiliary start winding and a start capacitor in series with the start winding. The apparatus comprises a sensing means for sensing the voltage across the main winding and across the start winding of the induction motor, a means for detecting a condition of the sensed voltages across the main and start windings that is indicative of the phase angle between the voltage across the main and start windings. The apparatus comprises a switching means for disconnecting the start capacitor from the start winding when the switching means is energized, and a microcomputer for energizing the switching means to disconnect the start capacitor from the start winding in response to determining when the phase angle between the voltage across the main winding and the start winding increases by more than a predetermined amount.

### FIELD OF THE INVENTION

The present invention relates to the control and monitoring of single phase induction motors having an auxiliary start winding and a start capacitor in series with the start winding. The monitoring function may be used with permanent split capacitor (PSC) motors as well.

### BACKGROUND OF THE INVENTION

In single phase induction motors for applications requiring relatively high starting torques, it is quite common to utilize a start capacitor. In such motors, the start capacitor is initially connected to the start or auxiliary winding of the motor to enable a high starting torque to be developed. It is desirable that the start capacitor be disconnected as soon as the motor has started properly and before the high current through the start winding, and the stress on the start capacitor, can damage the winding and capacitor. It is empirically known that the conditions at which disconnection is desired, exist when the motor speed has increased to approximately 80 percent of synchronous speed.

Various electromechanical devices, such as a voltage responsive potential relay, have been employed for effecting disconnection of the start capacitor. Such relays are typically mounted remote from the motor or mounted in a suitable enclosure so as to enable them to be used in conjunction with hermetically sealed apparatus. However, these relays are not directly responsive to the motor speed. In a typical relay circuit arrangement, the relay coil is connected in parallel with the start winding, and the normally-closed relay contacts and start capacitor are connected in series with each other and in series with the parallel-connected start winding and relay coil. The relay coil is energized to effect opening of its contacts when the voltage across it, which is also the voltage across the start winding, reaches a predetermined pull-in value. It is desired that the predetermined pull-in value occur at the same approximately 80 percent of synchronous speed previously described. Typically, an appropriate relay must be selected that has a pull-in voltage value corresponding to the voltage at which the particular motor reaches 80 percent of synchronous speed. Thus, numerous relays must be made available for the various voltage levels at which different motors reach 80 percent of synchronous speed. In addition, because of variations, such as fluctuations in line voltage, the value of the voltage across the start winding at a specific motor speed will vary. Thus, when the value of the voltage across the start winding is the parameter chosen for effecting relay operation, the motor speed at which the start capacitor is disconnected can vary considerably.

### SUMMARY OF THE INVENTION

Various embodiments of the present invention provide for control of single phase induction motors having an auxiliary start winding and at least a start capacitor in series with the start winding. One embodiment of the invention comprises an apparatus in combination with a single phase induction motor having a main winding, an auxiliary start winding and a start capacitor in series with the start winding. The apparatus comprises a sensing means for sensing the voltage across the main winding and across the auxiliary start winding of the induction motor, a means for detecting a condition of the sensed voltages across the main and auxiliary start windings that is indicative of the phase angle between the voltage across the main and auxiliary start windings, and a switching means for connecting the start capacitor in series with the auxiliary start winding when the switching means is de-energized, and for disconnecting the start capacitor from the auxiliary start winding when the switching means is energized. The apparatus further comprises a microcomputer for energizing the switching means to disconnect the start capacitor from the auxiliary start winding in response to determining when the phase angle between the voltage across the main winding and the voltage across the start winding increases by more than a predetermined amount, wherein the microcomputer de-energizes the switching means to re-connect the start capacitor to the auxiliary start winding in response to sensing a voltage condition across the auxiliary start winding indicative of a stall of the inductive motor.

In another aspect of the present invention, some embodiments of the invention comprise an apparatus that comprises a sensing means for sensing the voltage across the main winding and across the auxiliary start winding of the induction motor, a means for detecting a condition of the sensed voltages across the main and auxiliary start windings that is indicative of the phase angle between the voltage across the main and auxiliary start windings, and a microcomputer for monitoring the phase angle between the voltage across the main winding and the auxiliary start winding, and for responsively providing diagnostic information relating to the operation of the induction motor.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of an apparatus in accordance with the principles of the present invention, in combination with a single phase capacitor-start, capacitor-run induction motor having a main winding and an auxiliary start winding;

FIG. 2 is a graph illustrating the phase angle and torque with respect to motor speed in a capacitor-start, capacitor-run motor with the start capacitor connected in series with the auxiliary start winding;

FIG. 3 is a graph similar to FIG. 2 illustrating the phase angle and torque with respect to motor speed in a capacitor-start, capacitor-run motor with the start capacitor disconnected from the auxiliary start winding;

FIG. 4 is a schematic illustrating one embodiment of an apparatus for controlling a single phase motor;

FIG. 5 is a schematic illustrating a second embodiment of an apparatus for monitoring a single phase motor; and

FIG. 6 is a flow chart illustrating the method for controlling the apparatus in accordance with the principles of the present invention.

Corresponding reference numerals indicate corresponding parts throughout the several views of the drawings.

### DETAILED DESCRIPTION OF THE EMBODIMENTS

The following description of the various embodiments is merely exemplary in nature and is in no way intended to limit the invention, its application, or uses.

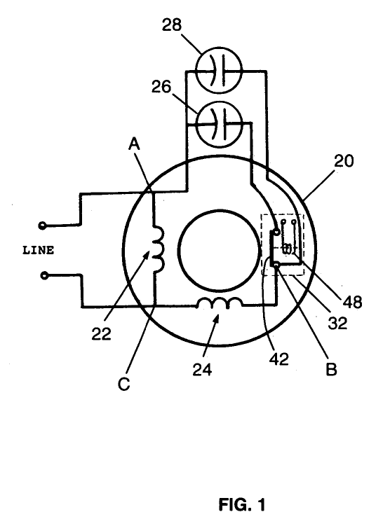

In one embodiment, an apparatus is provided for controlling a single phase capacitor-start, capacitor-run induction motor having a main winding and an auxiliary start winding and a start capacitor, as shown in FIG. 1. The motor 20 comprises a main winding 22, an auxiliary start winding 24, and a start capacitor 26 that is connected in series with the auxiliary start winding 24 upon energizing the motor to provide a phase difference between the main and auxiliary windings 22 and 24. It should be noted that in some embodiments of an apparatus for controlling a single phase motor, the motor may alternatively comprise only a start capacitor and not a run capacitor. The phase difference between the main and auxiliary windings 22 and 24 provides the starting torque that, if greater than the load, causes the motor to start rotating. Once the motor reaches approximately 80 percent of its synchronous speed, it is desirable to switch out the start capacitor from the auxiliary start winding circuit.

In one embodiment, the apparatus 30 comprises a switching means 32 for disconnecting the start capacitor 26 from the auxiliary start winding circuit. Specifically, the switching means 32 provides for connecting the start capacitor 26 in series with the auxiliary start winding 24 when the switching means 32 is de-energized, and for disconnecting the start capacitor 26 from the auxiliary start winding 24 when the switching means 32 is energized. The switching means in this embodiment is preferably a relay having normally closed contacts, but may alternately be a solid state switch such as a Triac.

In some embodiments, the apparatus 30 may comprise a first sensing means across nodes A and C for sensing a condition of the voltage across the main winding 22 of the induction motor 20, and a second sensing means across nodes B and C for sensing a condition of the voltage across the auxiliary start winding 24 of the induction motor 20. The first sensing means preferably comprises a voltage divider at 54 for sensing the voltage value across the main winding 22, but may alternately comprise a sensor for sensing a current value indicative of the sensed voltage across the main winding 22. Likewise, the second sensing means preferably comprises a voltage divider at 46 for sensing a voltage value representative of the voltage across the auxiliary start winding 24, but may alternately comprise a sensor for sensing a current value indicative of the sensed voltage across the auxiliary start winding 24.

An alternate voltage sensing implementation may use the voltage across the main and the capacitor voltage rather the to auxiliary winding voltage. Either implementation is related by the vector equation Vmain+Vauxiliary+Vcapacitor=0. In these embodiments the scalar values are of no interest. Only the direction or angle of the vectors provides useful information. The angles are related by this equation θ main+θ auxiliary+θ capacitor=180 degrees. The angle can be translated into the time domain by measuring either the zero voltage crossing point of the voltage vector of interest, or by measuring the logic state of the voltage vector after is passes through a fixed reference voltage level.

The apparatus 30 further comprises a microcomputer 38 that receives input (at 46 and 54) of the sensed voltages representative of the voltages across the main winding 22 and the auxiliary start winding 24, and determines a value that is indicative of the phase angle between the voltage across the main winding 22 and the auxiliary start winding 24. The microcomputer 38 responsively controls a triac 56 to energize the switching means 32 for disconnecting the start capacitor 26 from the auxiliary start winding circuit 24, in response to determining when the phase angle between the voltage across the main winding 22 and the voltage across the start winding 24 increases by more than a predetermined amount. The microcomputer 38 also comprises an output pin 58 for communicating diagnostic information relating to the operation of the motor 20.

Furthermore, motor operation can be monitored to determine if the motor is operating properly. Identification of system failure modes can provide active system protection to prevent damage and aid system troubleshooting and repair. Failure identification might include but is not limited to motor running properly, motor overloaded, motor stalled, motor protector tripped, main winding open, start winding open and capacitor open. Each failure mode may have a unique fault signature. Further areas of the controller 38 of the apparatus 30 of the present invention will become apparent from the detailed description of various embodiments provided hereinafter.

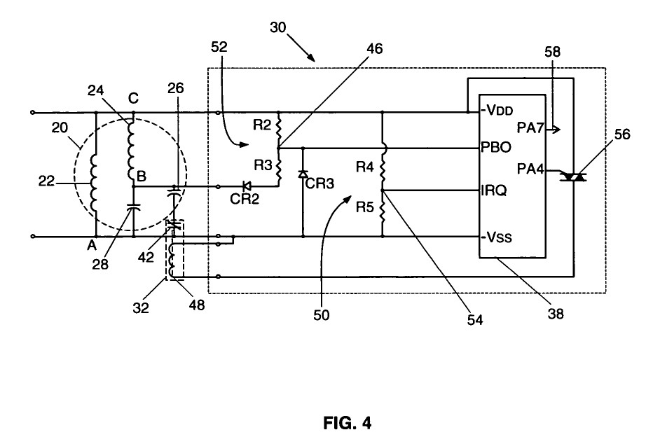

One embodiment of the apparatus 30 for controlling a single phase induction motor 20 is schematically shown in FIG. 4. When electrical power is initially applied to the main winding 22 and the auxiliary start winding 24 of the motor 20, power is also concurrently established by a low-voltage power supply for the microcomputer 38. The normally closed switching means 32 is de-energized so that the start capacitor 26 is connected in series with the auxiliary start winding 24. In this embodiment, the switching means is preferably a relay 32 having normally closed contacts 42 and a coil 48 that opens the contacts when energized. With the contacts 42 closed, the start winding 24 is energized by the line voltage through contacts 42 and start capacitor 26, and the motor 20 develops a starting torque which, if greater than the load, causes the motor to begin rotating.

After initial application of line voltage to the main winding 22, the voltage across the main winding 22 is periodically sensed at junction 54 by a first sensing means 50. In this embodiment, the first sensing means 50 is preferably a voltage divider circuit comprising resistors R4 and R5 across the main winding 22. The first sensing means 50 is preferably capable of periodically sensing the condition where the voltage across the main winding 22 has crossed zero volts and is increasing. When the first sensing means 50 detects this condition, the first sensing means provides an input to the microcomputer 38, which stores a time value indicative of when this condition in the voltage across the main winding 22 occurred. Likewise, the apparatus further comprises a second sensing means 52 that is preferably capable of periodically sensing voltage across the auxiliary start winding 24 at junction 46. In this embodiment, the second sensing means 52 is preferably a voltage divider circuit comprising resistors R2 and R3 across the auxiliary start winding 24. The second sensing means 52 senses the condition where the voltage across the auxiliary start winding 24 has crossed zero volts and is increasing. When the second sensing means 52 detects this condition, the second sensing means 52 provides an input to the microcomputer 38, which stores a time value indicative of when this condition in the voltage across the auxiliary start winding 22 occurred.

In one embodiment, the controller or microcomputer 38 is capable of monitoring these zero crossings of the voltage across the main and auxiliary start windings 22 and 24, and is preferably capable of monitoring the zero crossing point at every line cycle in the voltage across the main winding 22 and the auxiliary winding 24. The microcomputer 38 is further capable of determining a time difference value 40 from the sensed voltage conditions or zero cross points of the voltages across the main winding 22 and the auxiliary start winding 24. This time difference value 40 is indicative of the phase angle 60 between the voltage across the main winding 22 and the voltage across the auxiliary start winding 24. The microcomputer 38 is further capable of comparing the time difference value 40 between each periodically sensed zero cross occurrence in the voltage across the main and auxiliary start windings, with the immediately preceding time difference value between the preceding zero cross occurrence in the voltage across the main and auxiliary start windings. Thus, the microcomputer 38 is capable of determining from this time difference 40 whether the phase angle 60 between the voltage across the main winding 22 and the voltage across the auxiliary start winding 24 is increasing or decreasing, and at what rate.

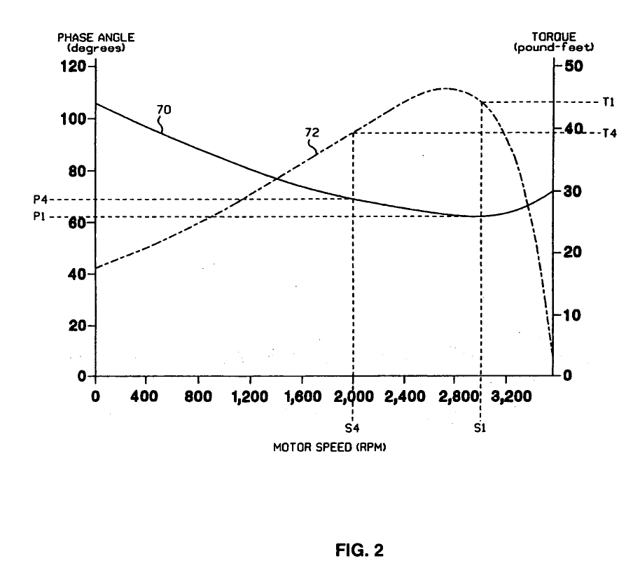

Referring to FIG. 2, a curve 70 illustrates the manner in which a phase angle 60 between windings 22 and 24 changes with respect to motor speed in a particular motor tested, such motor 20 being a 5-horsepower motor of the capacitor-start, capacitor-run type. As shown, the phase angle 60 is approximately 105 degrees when the motor speed is zero. As the motor speed increases, the phase angle 60 decreases. At a speed S1 of approximately 3000 RPM, when the phase angle is approximately 62 degrees, the phase angle stops decreasing and begins to increase. Microcomputer 38 responds to this increase in phase angle 60 by disconnecting start capacitor 26. Specifically, microcomputer 38 monitors the time difference values 40 between zero crossings of the voltage across main winding 22 and start winding 24 at junction points 54 and 46, respectively. When the phase angle 60 stops decreasing and begins to increase, microcomputer 38 provides an output that causes the coil of relay 32 to be energized, whereby its controlled contacts 42 open thereby disconnecting start capacitor 26 from auxiliary start winding 24. The microcomputer 38 is capable of monitoring voltage values during start up and running conditions, and can provide further improvements in the form of motor fault detection information such as a open winding, excessive motor load, a open capacitor, stalled motor, motor protector tripped or a relay fault.

Curve 72 in FIG. 2 illustrates the torque developed in the tested motor 20 with respect to motor speed. It is noted that the maximum torque occurs at a speed slightly less than speed S1. At speed S1, the torque is just a few pound-feet less than its maximum value. Thus, the torque being developed when the start capacitor 26 is disconnected is very near its maximum value. That the torque is at or near its maximum value when the start capacitor 26 is disconnected ensures that the motor 20 will not stall but rather will continue to run properly.

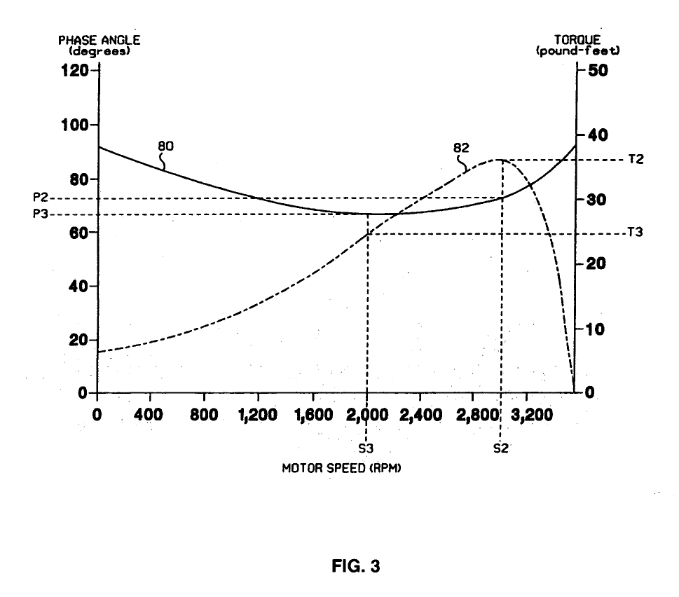

When start capacitor 26 is disconnected, the values of the torque and phase angle 60 change. Referring to FIG. 3, curves 80 and 82 therein illustrate the phase angle 60 and torque versus motor speed relationships, respectively, of the tested motor with start capacitor 26 disconnected. When start capacitor 26 is disconnected, the torque decreases from approximately 44 pound-feet indicated at T1 in FIG. 2 to approximately 36 pound-feet indicated at T2 in FIG. 3. The phase angle 60 also increases from approximately 62 degrees indicated at P1 in FIG. 2 to approximately 73 degrees indicated at P2 in FIG. 3. Typically, the motor has started properly so that the small drop in torque when start capacitor 26 is disconnected does not cause the motor 20 to stall due to the load requirements exceeding the available torque. The motor 20 then increases to a speed at which the torque produced by the motor equals the torque required by the load, such speed being slightly less than synchronous speed and sometimes being referred to as the slip speed.

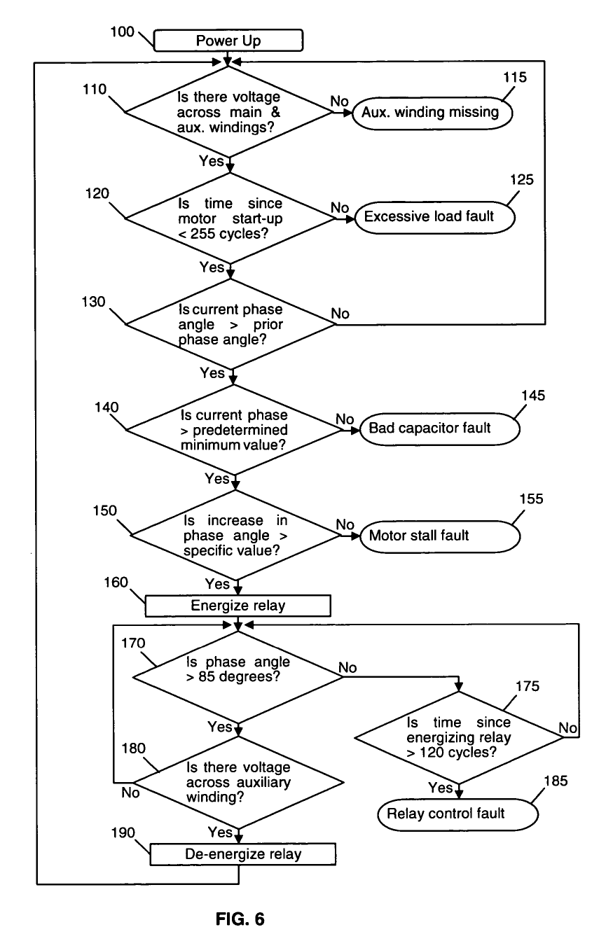

One embodiment of a method for controlling the apparatus for operating a single phase capacitor-start, capacitor-run induction motor having a main winding, an auxiliary start winding and a start capacitor is shown in FIG. 6. In operation, when electrical power is applied at step 100 to the main and auxiliary start windings 22 and 24 of the motor 20, the apparatus 30 checks the voltage sensing means to determine whether there is a voltage across the main and auxiliary start windings at step 110. If the apparatus determines that voltage is substantially absent either the main winding 22 or auxiliary start winding 24, the method provides for lock out of the apparatus at step 115, and provides a diagnostic communication indicating the missing main or auxiliary start winding voltage.

The method further provides for determining whether the phase angle 60 is increasing at step 130. If the sensed phase angle has not increased over the preceding sensed phase angle (and rather is decreasing while the motor speed is gradually increasing as shown in FIG. 2), then the method returns to step 100. If the time since the motor has started exceeds 255 line cycles at step 120 before an increase in phase angle is detected at step 130, the method provides for lock out of the apparatus at step 125, and provides a diagnostic communication indicating an excessive start load on the motor 20. If the method detects that the phase angle 60 has increased over the preceding phase angle, the method then proceeds to step 140.

As previously discussed, the motor 20 is at its maximum torque and is nearing 80 percent of its synchronous speed when the phase angle begins to increase rather than decrease, as determined at step 130. Thus, the method provides for energizing the relay at step 160 to cause the relay contacts to disconnect the start capacitor 26 from the auxiliary start winding 24, at such a time when the torque is sufficient to ensure that the motor 20 will not stall but rather will continue to run properly. The method further provides for checking whether there is a minimum phase angle present at step 140, indicating the presence of a bad start capacitor that is failing to provide a phase shift between the windings at step 145. The method also provides for verifying whether the phase angle 60 has changed more that a predetermined amount at step 150, indicating that the motor 20 has stalled at step 155.

Once the start capacitor 26 has been disconnected at step 160, the method monitors the phase angle 60 to verify whether the motor reaches full speed. If the phase angle is greater than 85 degrees at step 170 indicating that the motor has not reached full speed, the method checks at step 175 whether 120 line cycles have transpired since the relay was de-energized. If the motor does not reach full speed (as determined by a sensed phase angle of less than 85 degrees at step 170) within 120 line cycles at step 175, the method locks out the apparatus and provides a diagnostic communication indicating the motor is overloaded and cannot reach full speed after start up.

Once the start capacitor 26 has been disconnected at step 160 and the motor is operating normally, the method provides for monitoring the phase angle 60 between the voltage across the main and auxiliary start windings 22 and 24. If the motor 20 experiences a stall, the voltage in the auxiliary start winding will be lost or absent. Thus, the method is able to monitor the voltage sensing means in the auxiliary start winding for a voltage condition indicative of a stall at step 180. The method then provides for de-energizing the relay at step 190 to reconnect the start capacitor in series with the auxiliary start winding 24 to restart the motor 20.

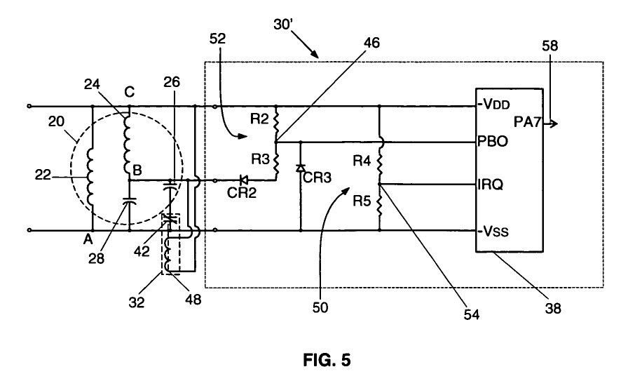

In a second embodiment of the apparatus 30′, the switching means 32 is not energized by the apparatus 30′ but rather by the voltage level across the start winding 24 as shown in FIG. 5. In this embodiment, the apparatus 30′ does not provide direct control of the motor 20, but does provide passive monitoring of phase with fault detection in the same manner as the first embodiment. Thus, the apparatus 30′ in the second embodiment may be used in applications where the motor controls switching of the start winding, and can provide the improvement of failure mode information relating to the motor 20 such as a bad winding, excessive motor load, a bad start capacitor, or a relay fault.

The description of the invention is merely exemplary in nature and, thus, variations that do not depart from the gist of the invention are intended to be within the scope of the invention. Such variations are not to be regarded as a departure from the spirit and scope of the invention.

1. An apparatus in combination with a single phase induction motor having a main winding, an auxiliary start winding and a start capacitor in series with the start winding, the apparatus comprising:
sensing means for sensing the voltage across the main winding and across the auxiliary start winding of the induction motor;
means for detecting a condition of the sensed voltages across the main and auxiliary start windings that is indicative of the phase angle between the voltage across the main and auxiliary start windings;
a switching means for connecting the start capacitor in series with the auxiliary start winding when the switching means is de-energized, and for disconnecting the start capacitor from the auxiliary start winding when the switching means is energized; and
a controller for energizing the switching means to disconnect the start capacitor from the auxiliary start winding in response to determining when the phase angle between the voltage across the main winding and the voltage across the start winding increases by more than a predetermined amount, wherein the controller de-energizes the switching means to re-connect the start capacitor to the auxiliary start winding in response to sensing a voltage condition across the auxiliary start winding indicative of a stall of the inductive motor.

2. The apparatus of claim 1 wherein the voltage condition indicative of a stall is an absence of a sensed voltage across the auxiliary start winding.

3. The apparatus of claim 1 wherein the sensing means comprises a voltage comparator for sensing the voltage value across the main winding and for sensing the voltage value across the auxiliary start winding.

4. The apparatus of claim 1 wherein the sensing means comprises a sensed current indicative of the sensed voltage across the main winding and a sensed current indicative of the sensed voltage across the auxiliary start winding.

5. The apparatus of claim 1 wherein the condition of the sensed voltages across the main and auxiliary start windings is the approximate time point where the sensed voltage across each winding crosses zero and is increasing.

6. The apparatus of claim 5 wherein the difference in time between the zero cross voltage conditions of the main and auxiliary windings is indicative of the phase angle between the voltage across the main and auxiliary start windings.

7. The apparatus of claim 1 where the predetermined amount is an increase in phase angle of at least 5 degrees.

8. The apparatus of claim 1 wherein the switching means comprises a relay having normally closed contacts.

9. An apparatus in combination with a single phase induction motor having a main winding, an auxiliary start winding and a start capacitor connected in series with the start winding, the apparatus comprising:
a first sensing means for sensing a condition of the voltage across the main winding of the induction motor;
a second sensing means for sensing a condition of the voltage across the auxiliary start winding of the induction motor;
a switching means for connecting the start capacitor in series with the auxiliary start winding when the switching means is de-energized, and for disconnecting the start capacitor from the auxiliary start winding when the switching means is energized; and
a controller for determining a value from the sensed conditions of the voltages across the main winding and the auxiliary start winding that is indicative of the phase angle between the voltage across the main winding and the auxiliary start winding, and for responsively energizing the switching means for disconnecting the start capacitor from the auxiliary start winding circuit in response to determining when the phase angle between the voltage across the main winding and the voltage across the start winding increases by more than a predetermined amount; whereupon energizing the switching means the controller monitors the second sensing means for sensing a voltage condition across the auxiliary winding that is indicative of a stall of the inductive motor

10. The apparatus of claim 9 wherein the controller responsively de-energizes the switching means to reconnect the start capacitor in series with the auxiliary start winding in response to detecting a voltage condition indicative of a stall of the inductive motor.

11. The apparatus of claim 10 wherein the voltage condition indicative of a stall is an absence of a sensed voltage across the auxiliary start winding.

12. The apparatus of claim 9 wherein the first sensing means comprises a sensor for sensing the voltage value across the main winding.

13. The apparatus of claim 9 wherein the first sensing means comprises a sensor for sensing a current value indicative of the sensed voltage across the main winding.

14. The apparatus of claim 12 wherein the second sensing means comprises a sensor for sensing the voltage value across the main winding.

15. The apparatus of claim 13 wherein the second sensing means comprises a sensor for sensing a current value indicative of the sensed voltage across the main winding.

16. The apparatus of claim 9 wherein the conditions of the first and second sensing means is the approximate point where the voltage across the main winding crosses zero and is increasing, and the approximate point where the voltage across the main winding crosses zero and is increasing.

17. The apparatus of claim 16 where the value indicative of the phase angle is the difference in time between the zero cross of the voltage across the main winding and the zero cross of the voltage across the auxiliary start winding.

18. The apparatus of claim 17 where the predetermined amount is an increase in phase angle of at least 5 degrees.

19. The apparatus of claim 9 wherein the switching means comprises a relay having normally closed contacts.

20.-21. (canceled)

21. An apparatus in combination with a single phase induction motor having a main winding, an auxiliary start winding and a start capacitor connected in series with the start winding, the apparatus comprising:
a switching means for connecting the start capacitor in series with the auxiliary start winding, wherein the switching means is configured to disconnect the start capacitor from the auxiliary start winding when the switching means is energized;
a first sensing means for sensing a condition where the value of the voltage across the main winding of the induction motor has crossed zero and is increasing;
a second sensing means for sensing a condition where the value of the voltage across the auxiliary start winding of the induction motor has crossed zero and is increasing; and
a controller that receives inputs from the first and second sensing means, and is configured to store time values indicative of occurrences of when the voltage across the main winding has crossed zero, and to store time values indicative of occurrences of when the voltage across the auxiliary start winding has crossed zero, the controller being configured to determine a time difference between the time values associated with the most recent occurrence of a sensed zero-cross voltage condition of the main and auxiliary windings that is indicative of the phase angle between the voltage across the main winding and auxiliary winding, and to compare the time difference to the immediately preceding time difference between the time values associated with the previously sensed zero-cross voltage condition of the main and auxiliary windings, to determine when the phase angle is increasing, wherein the controller is configured to energize the switching means to disconnect the start capacitor from the auxiliary start winding circuit in response to determining when the phase angle between the voltage across the main winding and the voltage across the start winding increases by more than a predetermined amount; and whereupon energizing the switching means the controller is configured to monitor the second sensing means for a sensing a voltage condition indicative of a stall of the inductive motor and to de-energize the switching means to reconnect the start capacitor in series with the auxiliary start winding in response to detecting a voltage condition that is indicative of a stall.
